(19) United States
(12) Patent Application Publication
(10) Pub. No.: US 2003/0035559 A1
(43) Pub. Date: Feb. 20, 2003

(54) Trackball controller for built-in effects

(76) Inventor: Laurent Cohen, Ft. Lauderdale, FL (US)

Correspondence Address: Gerald Levy, Esq., PITNEY, HARDIN, KIPP & SZUCH LLP, 711 Third Avenue, New York, NY, 10017-4059, US

(21) Appl. No.: 09/931,329

(22) Filed: Aug. 16, 2001

(51) Int. Cl. H04B 1/00

(52) U.S. Cl. 381/119; 381/109

(57) ABSTRACT

The apparatus includes a trackball with variable potentiometers for an audio mixer. The trackball can rotate with at least two degrees of freedom, so that rotation in the first direction as detected by a first variable potentiometer controls a first variable, such as regeneration of an audio effect and rotation in the second direction as detected by a second variable potentiometer controls a second variable, such as speed of the audio effect.

### BACKGROUND OF THE INVENTION

1. Field of the Invention

This invention pertains to a trackball controller for an audio mixer or similar device wherein the trackball controller has two degrees of freedom which adjust the regeneration and the speed of the effect being used.

2. Description of the Prior Art

In the prior art, it is known to use audio mixers in order to generate any number of desired audio effects. However, these audio mixers have a large number of dials and switches so that the operation of the controls has not been intuitive. In particular, there are effects which are frequently changed simultaneously, such as regeneration of the effect and the speed of the effect being used. It can be awkward for an operator, such as a disk jockey, to operate two controls simultaneously, particularly if the operator is inexperienced.

### OBJECTS AND SUMMARY OF THE INVENTION

It is therefore an object of the present invention to provide an audio mixer which has reduced complexity.

It is therefore a further object of the present invention to provide an audio mixer which can be used intuitively.

It is therefore a still further object of the present invention to provide an audio mixer wherein two variables can be varied simultaneously by a single control, operated by a single hand.

These and other objects are attained by providing an audio mixer with a trackball controller with at least two degrees of freedom. The trackball controller can therefore control two variables simultaneously, such as regeneration of the effect and the speed of the effect being used.

### BRIEF DESCRIPTION OF THE DRAWING

Further objects and advantages of the invention will become apparent from the following description and claims, and from the accompanying drawing, wherein:

FIG. 1 is a plan view of at least a portion of the control panel of the audio mixer of the present invention.

### DETAILED DESCRIPTION OF THE PREFERRED EMBODIMENT

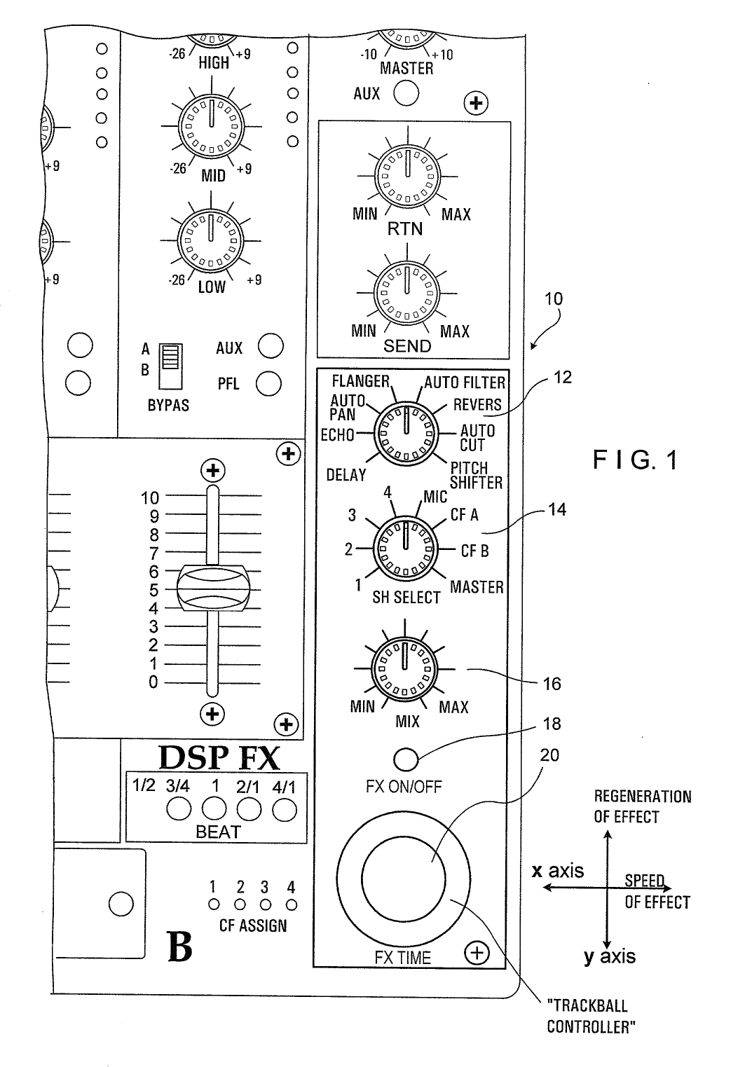

Referring now to the drawings in detail wherein like numerals refer to like elements throughout the several views, one sees that FIG. 1 is a plan view of at least a portion of the control panel 10 of the audio mixer of the present invention.

Control panel 10 includes a series of five control devices for an audio signal—selector switch 12 which assigns the type of audio effect to be used, selector switch 14 which assigns the channel to which the effect will be assigned, potentiometer 16 which assigns the level of the effect which will be mixed into the outgoing signal, effect ON/OFF switch 18 which is used to turn the effect “on” and “off” and multi-axis trackball 20.

Multi-axis trackball 20 includes two variable potentiometers (not shown) and responds to motion in at least two degrees of freedom in that it can respond to rotation about an axis which is horizontal in the orientation illustrated in FIG. 1 or respond to rotation about an axis which is vertical in the orientation illustrated in FIG. 1. Rotation about the horizontal axis (that is, upward or downward movement of the trackball) typically controls regeneration of the effect while rotation about the vertical axis (that is, side-to-side movement of the trackball) typically controls the speed of the effect. Additionally, these rotations can be simultaneously combined so that the trackball is rotated about some axis which inclined with respect to the orientation illustrated in FIG. 1. This allows for a user to control both variables simultaneously while using a single hand.

Thus the several aforementioned objects and advantages are most effectively attained. Although a single preferred embodiment of the invention has been disclosed and described in detail herein, it should be understood that this invention is in no sense limited thereby and its scope is to be determined by that of the appended claims.

What is claimed is:

1. In an audio mixer of the type including multiple controls, the improvement comprising a trackball which can rotate with at least two degrees of freedom thereby controlling two variables.

2. The improvement of claim 1 wherein a first variable is controlled by rotation of said trackball about a first axis and a second variable is controlled by rotation of said trackball about a second axis.

3. The improvement of claim 2 wherein said first axis is perpendicular to said second axis.

4. The improvement of claim 3 wherein said first variable is speed of an audio effect and said second variable is regeneration of an audio effect.

5. The improvement of claim 4 further including a selector switch for selecting the audio effect to be used.

6. The improvement of claim 5 further including a channel selector for selecting an audio channel for the audio effect.

7. The improvement of claim 6 further including a potentiometer to assign the level of the audio effect to be used.

8. The improvement of claim 7 further including an ON/OFF switch for the audio effect to be used.
